(19) United States
(12) Patent Application Publication
(10) Pub. No.: US 2017/0218890 A1
(43) Pub. Date: Aug. 3, 2017

(54) A TURBOMACHINERY ASSEMBLY FOR AN INTERNAL COMBUSTION ENGINE USING A VENTURI APPARATUS

(71) Applicant: BOOST MECHANICS (PTY) LIMITED, Pretoria (ZA)

(72) Inventor: Ipeleng Samson Mathebula, Midrand (ZA)

(21) Appl. No.: 15/514,766

(22) PCT Filed: Sep. 28, 2015
(86) PCT No.: PCT/IB15/57418

§ 371 Date: Mar. 27, 2017

(30) Foreign Application Priority Data
Sep. 29, 2014 (ZA) 2014/07070

(51) Int. Cl. F02M 35/10; F02B 37/24; F02D 41/00; F02B 29/04; F02B 37/16; F02B 37/22

(52) U.S. Cl. CPC F02M 35/10118; F02B 37/168; F02B 37/225; F02M 35/10157; F02M 35/1038; F02D 41/0007; F02B 29/045; F02B 37/24

(57) ABSTRACT

According to a first aspect of the invention, there is provides a turbo machinery assembly for an internal combustion engine, the turbo machinery assembly including: a bypass flow compensated Mass Air Flow (MAF) sensor for measuring the amount of intake air; exhaust gas or engine driven compressor operable to compress an input stream of air, the compressor having a compressed air outlet which branches into at least a first branch and a second branch; a first branch of said air outlet being connected to an engine, having a charge air cooler, with the second branch adding a secondary path and so as to enable said second branch of said air outlet to operatively control the intake manifold pressure and charge mass flow rate.

### FIELD OF INVENTION

This invention relates to internal combustion engines, and more particularly to a turbomachinery assembly and forced induction air supply of an engine. The invention further relates to an associated method of reducing turbo lag, pumping losses and exhaust emissions in a manner that enables the fuel economy/efficiency of internal combustion engines to be enhanced.

### BACKGROUND OF INVENTION

The power output of a typical engine is directly proportional to the amount of fuel being burned for producing useful work. The amount of fuel that can be burnt is a function of the amount of air or oxygen flowing through the engine. Hence, power output can be regulated by controlling fuel and/or air intake. Air intake can be simply altered by changing engine speed or varying airflow rate through the engine by using techniques such as throttling.

Conventional throttling techniques limit airflow by introducing flow restrictions like butterfly throttles, which adversely affect efficiency at low engine loads. Engine downsizing, downspeeding and turbocharging is an example of a method that reduces throttling losses under part load conditions. Downsizing and downspeeding reduce the amount of airflow in such a manner that less throttling is required to achieve the same power output when boost pressures are small or negligible. However, a rapid increase in load under these conditions requires high engine speeds and/or minimal turbo lag which can't be readily achieved during in gear accelerations.

Thus, there are various methods which intend to ameliorate problems associated with turbo-lag and/or throttling losses. Variable Turbine Geometry (VTG) turbochargers is one of the techniques employed in controlling boost pressure and airflow through the engine by simply varying the turbine housing's aspect ratio. The VGT turbocharger is effective in reducing turbo-lag and adding a degree of throttling, however, the solution introduces complex moving parts that are sensitive to high temperatures and are not readily suitable for gasoline applications.

Yet another technique of reducing turbo-lag that is suitable for gasoline engines is employing an electronic wastegate. The typical control circuit or ECU of such an engine opens the turbocharger wastegate under part load conditions to reduce boost pressure and then regulates the boost pressure to achieve predetermined pressure set points when throttle inputs change. A problem with this method of controlling the amount of exhaust gas that passes the turbine is that most of the by-passed gases are lost to the environment—they are wasted as the name of the wastegate implies.

The Applicant thus wishes to provide an affordable turbomachinery assembly and associated method which redeploys gas that would otherwise be wasted. Advantageously, the assembly ensures that the residual energy in exhaust gases are is purged optimally to reduce turbo-lag and pumping losses while supplying excess air for reducing carbon monoxide (CO), unburnt hydrocarbon (HCs) and Nitrogen Oxides (NOx) emissions levels.

### SUMMARY OF INVENTION

According to a first aspect of the invention, there is provided a turbomachinery assembly for an internal combustion engine, the turbomachinery assembly including:

a Mass Air Flow (MAF) sensor for measuring the amount of incoming air; compressor operable to compress an input stream of air, the compressor having a compressed air outlet which branches into at least a first branch and a second branch;
a first branch of said air outlet being connected to an engine, having a charge air cooler, with the second branch of said air outlet being connected to three possible options so as to add a secondary path and so as to enable said second branch of said air outlet to operatively control the intake manifold pressure;
   a venturi apparatus or connection point having a motive inlet, at least one feed inlet, and an outlet, wherein:
the feed inlet may be connected directly or indirectly to either the compressor or turbine outlet,
the motive inlet may be connected directly or indirectly to either the turbine or compressor outlet in such a manner that the motive and feed inlet do not share flow sources, and
the venturi outlet is connected, either directly or indirectly, to an exhaust network for conveying exhaust gases to the atmosphere.

In an embodiment of the invention, the turbomachinery assembly further comprises one or more of the following:
a venturi apparatus or connection point in the exhaust including a valve operable to control the amount of air bypassing the engine;
a hole defined in the venturi apparatus, said hole being operable to vent a portion of the charge air to the atmosphere;
a recirculation, diverter or dump valve operable to reduce or regulate the intake manifold pressure by recirculating, diverting or venting a portion of the charge air.

In an embodiment of the invention, said venturi apparatus or connection point includes a valve operable to control the amount of air bypassing the engine.

In an embodiment of the invention, the second branch of said air outlet is operable, after the compressor, to decrease intake manifold pressure thereby reducing pumping losses through the engine under part-load conditions.

In an embodiment of the invention, the venturi apparatus is operable to employ a fraction of the compressed intake air from the compressor outlet as a motive fluid that is operable to create a partial vacuum for entraining and conveying exhaust gases through the exhaust system.

In an alternative embodiment of the invention, the motive inlet of the venturi is operable to use exhaust gases to depressurize the intake manifold so as to operably reduce throttling losses further.

In an embodiment of the invention, the venturi apparatus is operable to introduce fresh air through the venturi so as to operably allow for unwanted pollutants like unburnt hydrocarbons (HC) and Carbon Monoxide (CO) to be oxidized.

In an embodiment of the invention, the valve on the second path of the compressor outlet is operable to allow the engine to increase boost pressures and reduce turbo lag by throttling the flow through the secondary path during load increments. It is to be appreciated that such an arrangement may allow for further engine downsizing and down-speeding to potentially achieve increased fuel economy.

In an embodiment of the invention, said assembly includes a Manifold Absolute Sensor (MAP) or boost pressure sensor which is operable to work in conjunction with other sensors to provide the engine ECU with information for fuel metering purposes.

In an embodiment of the invention, the turbomachinery assembly may include an intercooler. In this embodiment of the invention, the intercooler may be arranged downstream of the compressor. In this embodiment, the intercooler may be arranged before or after the second branch. It may be more beneficial to have the intercooler after the second branch to minimise pumping losses through the intercooler.

In embodiment of the invention, the engine is allowed to burn gasoline, diesel or other alternative fuels. In this embodiment, the engine is operable to operate over a range of fuel air ratios depending on the tuning and method of fuel injection. In this embodiment, throttling techniques like butterfly valve and/or variable valve timing may be used to operatively control the amount of air flowing through the engine.

In an embodiment of the invention, the engine exhaust manifold outlet is connected directly to the turbine inlet, said turbine inlet including a wastegate path operable to bypass the turbine so as to control boost pressure. In this embodiment, the turbine may be a part of variable geometry turbine, single or twin scroll turbocharger.

In an embodiment of the invention, the engine is fitted with an oxygen sensor or lambda sensor on the exhaust side for combustion control and/or controlling the effectiveness of the emission treatment apparatus. In this embodiment, the oxygen sensors are furnished with a heating element for improving accuracy during cold start-ups and/or part load operations when there is insufficient exhaust gas heat.

In an embodiment of the invention, an emission treatment apparatus is installed before or after the venturi apparatus or connection point depending on the requirement of excess oxygen for reducing emissions.

In an embodiment of the invention, the venturi apparatus introduces an obstruction which serves to operatively reduce the area of the fluid flow path, thereby to increase flow speed around the obstruction and to decrease the local static pressure, in use, so as to create the venturi effect.

In an embodiment of the invention, the leading edge of the obstruction in the venturi apparatus or connection point may be curved, flat or bluff body so as to operatively reduce the effective flow area while creating a flow separation region behind the obstruction in the absence of feed flow.

In an embodiment of the invention, the obstruction may be provided by a blind circular feed conduit entering the motive conduit at an angle. In this embodiment, the feed conduit may enter the motive conduit at an inclined angle.

Different embodiments may realise slightly different advantages with different operating characteristics and this will be described more fully below.

### BRIEF DESCRIPTION OF DRAWINGS

The invention will now be further described, by way of example, with reference to the accompanying diagrammatic drawings.

In the drawings:

FIG. 1 shows a schematic diagram of the generic embodiment of the turbomachinery assembly;

FIG. 2 shows the method for reducing turbo-lag and pumping losses on a compressor map (Absolute pressure against Mass flow rate);

FIG. 3 shows a schematic diagram of first embodiment of a turbomachinery assembly in accordance with the invention;

FIG. 4 shows schematic diagram of the second embodiment of a turbomachinery assembly in accordance with the invention;

FIG. 5 shows schematic views of the first embodiment of a venturi apparatus of the assembly of FIG. 3 and FIG. 4;

FIG. 6 shows schematic views of a second embodiment of a venturi apparatus of the assembly of FIG. 3 and FIG. 4;

### DETAILED DESCRIPTION OF EXAMPLE EMBODIMENT

The following description of the invention is provided as an enabling teaching of the invention. Those skilled in the relevant art will recognise that many changes can be made to the embodiment described, while still attaining the beneficial results of the present invention. It will also be apparent that some of the desired benefits of the present invention can be attained by selecting some of the features of the present invention without utilising other features. Accordingly, those skilled in the art will recognise that modifications and adaptations to the present invention are possible and can even be desirable in certain circumstances, and are a part of the present invention. Thus, the following description is provided as illustrative of the principles of the present invention and not a limitation thereof.

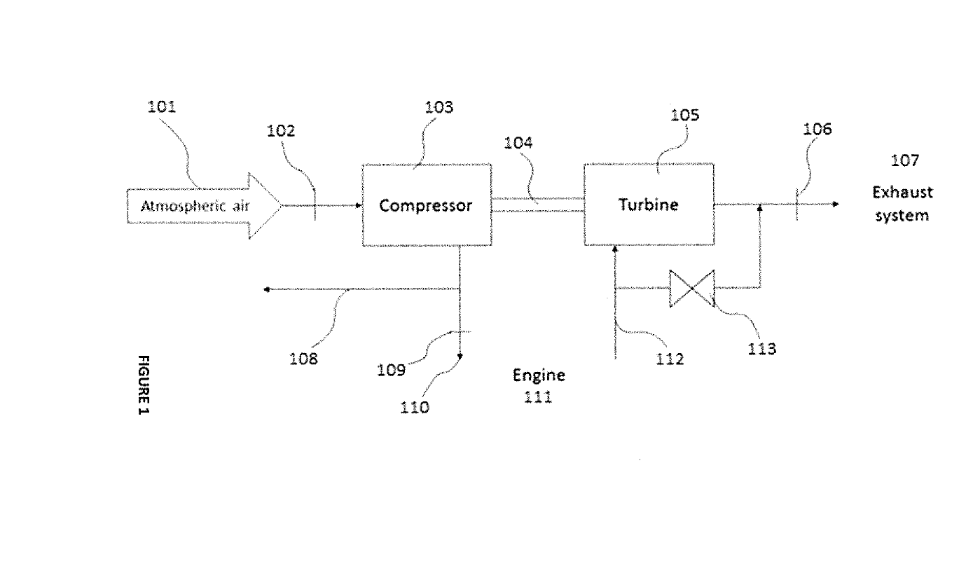

FIG. 1 illustrates a generic embodiment of the turbomachinery assembly. The turbomachinery assembly forms part of an internal combustion engine assembly. The engine 111 may be spark ignition (e.g., petrol fuelled), compression ignition (e.g., diesel fuelled) or other fuels. The engine may be reciprocating, rotary or an alternative arrangement which allow for energy to be extracted by burning fuel.

The turbomachinery assembly includes some conventional components. More specifically, the turbomachinery assembly has a compressor 103 which has a compressor inlet operable to draw in atmospheric air 101. There will likely be other conventional components which are not illustrated (e.g., an air filter) but only those components which are germane to the invention are illustrated. The compressor 103 is driven by a turbine 105 which is connected to the compressor 103 by means of a mechanical shaft 104. A turbine outlet is directed to an exhaust system 107 comprising of components like emission treatment apparatus (e.g., a catalytic converter, muffler and silencer)

In accordance with the invention, the compressor 103 outlet splits into two branches. The first branch 110 supplies intake air into the engine 111 and the second path 108 is used for tuning the pneumatic resistance after the compressor outlet. The second path 108 may be connected to a venturi 500 or 600, atmosphere, diverter or recirculation valve. The flow through the second path 108 may be regulated by a valve 305 or 405 that receives control signals from the ECU (not shown). The ECU may use oxygen sensors 106, manifold absolute pressure sensors 109, corrected mass air flow sensor 102 and other signals (e.g., throttle input signals) to control fuel metering and air intake.

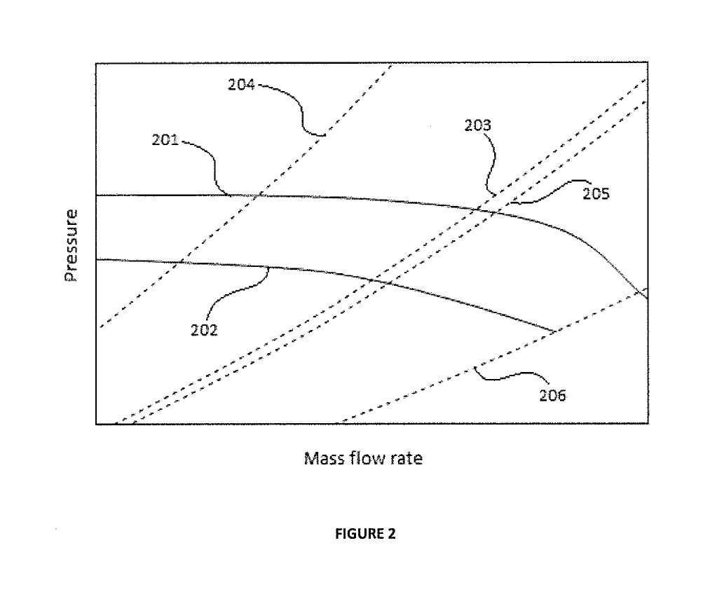

FIG. 2 illustrates the effect of the second path 108 after the compressor 103 outlet by example. The resistance line 203 at Wide Open Throttle (WOT) is assumed to coincide with the line of maximum compression efficiency. The airflow at part load is conventionally reduced by increasing the flow resistance through the engine as shown by line 204. The first compressor wheel speed line 202 indicates that a sudden load step from part to full load may result with an increase in mass flow rate with a slight decrease in manifold pressure, thereby causing turbo lag before maximum torque/power is attained.

The second path 108 in this invention introduces an additional path which reduces the overall flow resistance of the engine assembly. This reduction in flow resistance, line 206, causes a drop in intake pressure and higher mass flow rates when compared to the WOT resistance line 203 at the same compressor wheel speed 202. The drop in pressure is beneficial for minimising throttling losses and air intake is managed by diverting, venting or recirculating the excess flow.

A sudden load increment in this case results with an increase in manifold pressure and a reduction in excess flow when second path 108 is throttled. The effect of throttling the second path 108 is more pronounced at higher compressor wheel speeds line 201. This method reduces turbo lag and makes excess air available for treating exhaust emissions when required.

A tuned passive resistance path that does not have an active valve causes the compressor wheel to rotate slightly faster to maintain the desired boost pressure. Line 205 illustrates an example of the tuned resistance path and the engine-intake mass flow rate decoupling under WOT conditions. The mass flow rate decoupling provides a spooling lead at the expense of allowing excess air flow to bypass the engine.

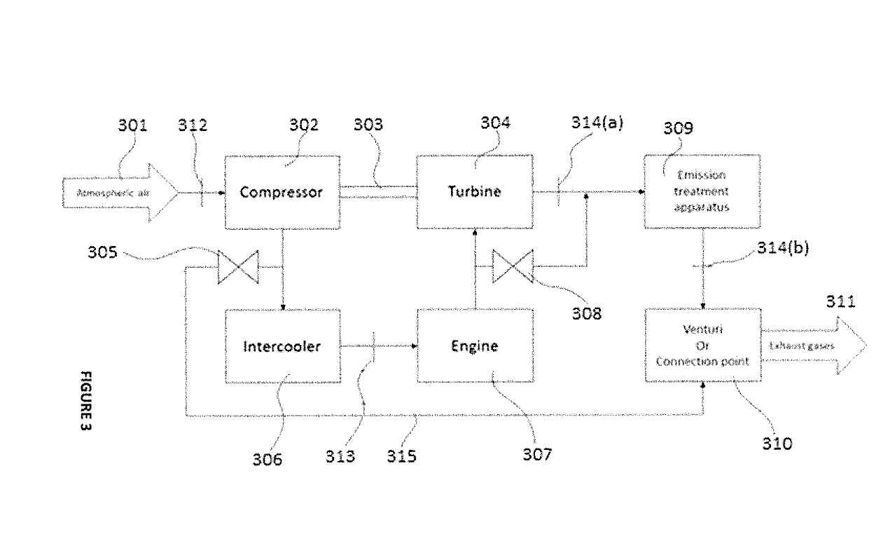

FIG. 3 shows a schematic diagram of first embodiment of a turbomachinery assembly in accordance with the invention. This embodiment is ideal but it is not limited to spark ignition or gasoline engines 111 with three-way catalytic converters 309 that reduce exhaust emissions optimally when the fuel is burned close to the stoichiometric ratio.

Intake air 301 is compressed by the compressor 302 which may be a shaft driven compressor like a supercharger. The first path 110 of the compressor outlet goes through the intercooler 306 which may be a liquid-air or air-air intercooler that is installed upstream of the engine 307 intake manifold. The exhaust gases from the engine 307 exhaust manifold may be fed through a VGT, single or twin scroll turbine housing and turbine 304 that may or may not have a wastegate 308 when a turbine is installed as part of charge air assembly. The exhaust gases are then fed directly to the emission treatment device 309 before mixing with the bypass air.

The venturi or connection point 310 may be used in two ways. The first and ideal iteration uses the exhaust gases that are compressed by the engine 307 as motive fluid 505 or 605 for entraining excess air in the feed line 502 or 602 of the venturi.

This arrangement reduces the manifold intake pressure during part load such that engine pumping losses are reduced. It is ideal to employ a control valve 305 that increases flow resistance in the second path 108 at full load to allow the intake manifold to accumulate enough pressure to increase engine torque and power output. The advantage of this embodiment is usable for turbocharged, supercharged and normally aspirated engines.

The second iteration of the venturi installation may be passive or regulated by a control valve 305. The motive duct 501 or 601 may be connected to second or bypass flow path 108 and the feed line 502 or 602 may be connected to the exhaust gases exiting the emission treatment device 309. In both iterations, the exhaust gases and excess air mixture exit through the outlet pipe 503 or 603 of the venturi to the remainder of the exhaust system. A bypass flow compensated MAF sensor 312 or MAP 313 may be used for fuel metering and oxygen sensors 314a and/or 314b may be used as feedback for controlling the combustion process.

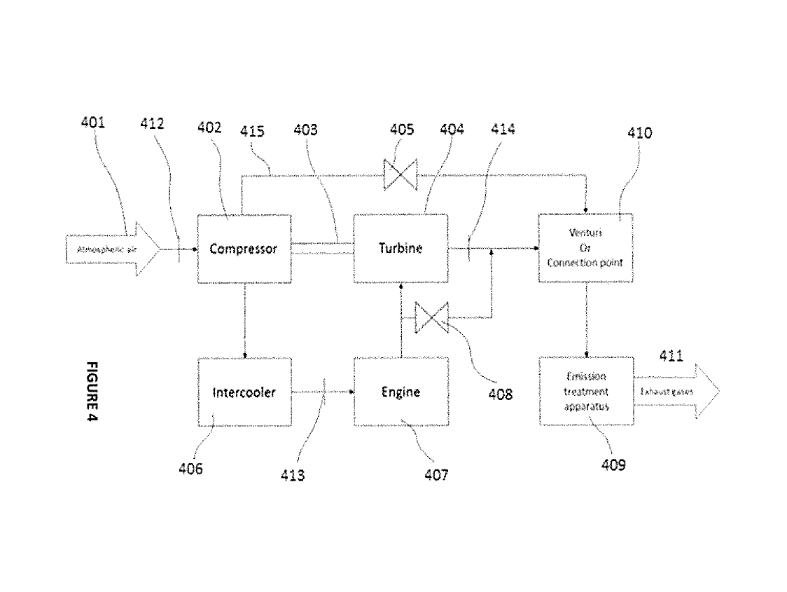

FIG. 4. Shows a schematic diagram of the second embodiment of a turbomachinery assembly in accordance with the invention. This embodiment is ideal but it is not limited to ultra-lean burn gasoline and compression ignition engines 111 with emission treatments apparatus 409 that requires excess air or oxygen to operate effectively. These apparatus include but are not limited to Diesel Oxidation Catalysts (DOC), two-way catalytic converters and Selective Catalytic Reduction (SCRs).

This embodiment is similar to the first embodiment with the exception of the installation of the venturi or connection 410. It is ideal to connect the second path 108 to the venturi motive line 501 or 601 with the feed line 502 or 602 being downstream of the turbine 404 outlet. The outlet of the venturi 503 or 603 is connected upstream to the emission treatment apparatus 409 to ensure that there is always sufficient or excess air to treat exhaust emissions.

The second path may be passive without a control valve 405 using tuned resistance line 205 or may have adjustable throttling in analogous manner presented in the first embodiment. A MAP 413 or bypass flow compensated MAF sensor 412 may be used for fuel metering and oxygen sensors 314a and/or 314b may be used as feedback for controlling the combustion process.

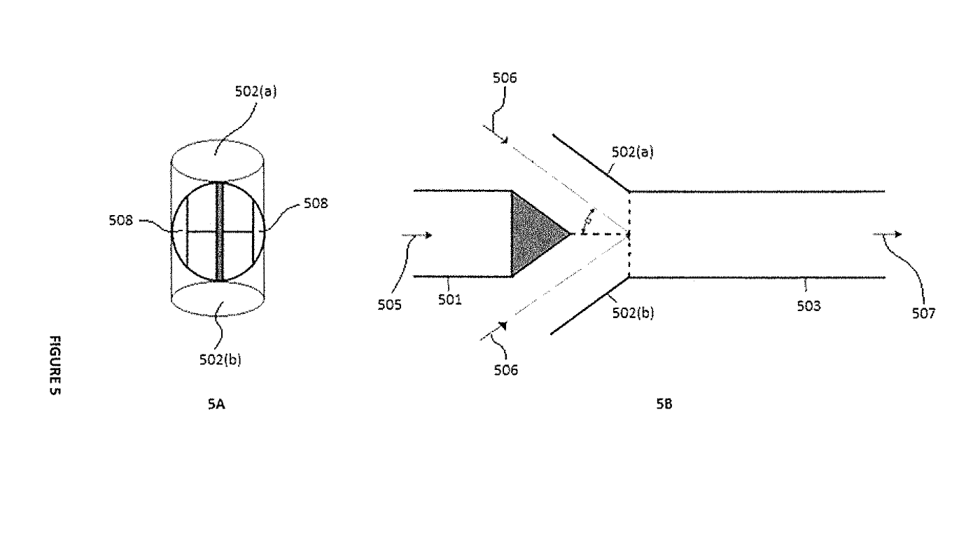

FIG. 5 shows a schematic diagram of first embodiment of the venturi apparatus or connection point. The motive fluid 505 enters the venturi through the motive fluid duct 501. Feed flow 506 may enter the device through two feed tubes 502a and 502b that are inclined in the direction of the motive flow. The cylindrical feed tubes 502a and 502b that reduce the flow area 508 while encouraging flow separation in the region where the feed flow 506 is entrained. The flow mixture 507 exits the venturi through the outlet duct 503.

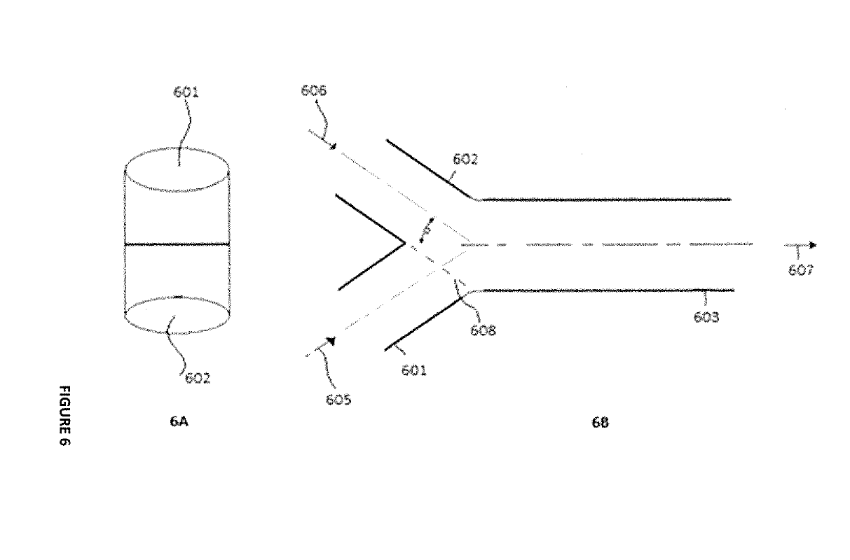

FIG. 6. Shows a schematic diagram of second embodiment of the venturi apparatus or connection point. The motive fluid 605 enters the venturi at an angle and a single feed tube 602 may be used to create a similar obstruction to the one mentioned in FIG. 5. The feed reduces that flow area 608 of the motive fluid such that the venturi effect is achieved. Both streams 607 exit the venturi in through duct 603.

1. A turbomachinery assembly for an internal combustion engine, the turbomachinery assembly including:
a bypass flow compensated Mass Air Flow (MAF) sensor for measuring the amount of intake air; exhaust gas or engine driven compressor operable to compress an input stream of air, the compressor having a compressed air outlet which branches into at least a first branch and a second branch;
a first branch of said air outlet being connected to an engine, having a charge air cooler, with the second branch adding a secondary path and so as to enable said second branch of said air outlet to operatively control the intake manifold pressure and charge mass flow rate.

2. A turbomachinery assembly as claimed in claim 1, wherein said second branch of said turbomachinery assembly is connected to one or more of the following:
a venturi apparatus or connection point in the exhaust including a valve operable to control the amount of air bypassing the engine;
a venturi apparatus or connection point in the exhaust including a tuned throat area for intake-engine mass flow rate decoupling;
a hole equivalent to the tuned venturi throat area, said hole being operable to vent a portion of the charge air to the atmosphere; and
a recirculation valve operable to continuously regulate intake manifold pressure by recirculating a portion of the charge air.

3. A turbomachinery assembly as claimed in claim 2, wherein said venturi apparatus having a motive inlet, at least one feed inlet and an outlet, wherein:
the feed inlet is connected directly or indirectly to either the compressor or exhaust manifold outlet,
the motive inlet is connected directly or indirectly to either the exhaust manifold or compressor outlet in such a manner that the motive and feed inlet do not share flow sources, and
the venturi outlet is connected, either directly or indirectly, to an exhaust network for conveying exhaust gases to the atmosphere.

4. A turbomachinery assembly as claimed in any of claims 1 to 3, wherein the valve on the second path of the compressor outlet is operable to allow the engine to increase boost pressures and reduce turbo lag by throttling the flow through the secondary path during load increments.

5. A turbomachinery assembly as claimed in any of the preceding claims, wherein the second branch of said air outlet is operable, after the compressor, to decrease intake manifold pressure thereby reducing pumping losses through the engine under part-load conditions.

6. A turbomachinery assembly as claimed in claim 5, wherein the motive inlet of the venturi is operable to use exhaust gases to depressurize the intake manifold so as to operably reduce throttling losses further.

7. A turbomachinery assembly as claimed in any of the preceding claims, wherein the venturi apparatus is operable to employ a fraction of the compressed intake air from the compressor outlet as a motive fluid that is operable to create a partial vacuum for entraining and conveying exhaust gases through the exhaust system.

8. A turbomachinery assembly as claimed in any of the preceding claims, the venturi apparatus is operable to introduce fresh air through the venturi so as to operably allow for unwanted pollutants like unburnt hydrocarbons (HC) and Carbon Monoxide (CO) to be oxidized.

9. A turbomachinery assembly as claimed in any of the preceding claims, wherein said assembly includes a Manifold Absolute Sensor (MAP) or boost pressure sensor which is operable to work in conjunction with other sensors to provide the engine ECU with information for fuel metering and charge air control purposes.

10. A turbomachinery assembly as claimed in any of the preceding claims, the turbomachinery assembly may include an intercooler.

11. A turbomachinery assembly as claimed in claim 10, wherein the intercooler is arranged downstream of the compressor.

12. A turbomachinery assembly as claimed in any of claim 10 or 11, wherein the intercooler is arranged before or after the second branch.

13. A turbomachinery assembly as claimed in any of claims 10 to 12, wherein the intercooler is provided after the second branch to minimise pumping losses through the intercooler.

14. A turbomachinery assembly as claimed in any of the preceding claims, the engine employing indirect injection or direct injection with the capability of compression and/or spark ignition.

15. A turbomachinery assembly as claimed in claim 14, wherein the engine is operable to operate at ultra-lean, lean, stoichiometric and/or rich burn fuel ratios.

16. A turbomachinery assembly as claimed in any of claims 14 to 15, wherein throttling techniques like butterfly valve and/or variable valve timing is used to operatively control the amount of air flowing through the engine.

17. A turbomachinery assembly as claimed in any of the preceding claims, wherein the engine outlet is connected directly to the turbine inlet, said turbine inlet including a wastegate path operable to bypass the turbine so as to control pressure.

18. A turbomachinery assembly as claimed in claim 17, wherein the turbine is a part of variable geometry turbine, single or twin scroll turbocharger.

19. A turbomachinery assembly as claimed in any of the preceding claims, wherein the engine is fitted with an oxygen sensor or lambda sensor on the exhaust side for providing feedback for controlling the combustion process.

20. A turbomachinery assembly as claimed in any of the preceding claims, wherein the oxygen sensors are furnished with a heating element for improving accuracy during cold start-ups and/or part load operations when there is insufficient exhaust gas heat.

21. A turbomachinery assembly as claimed in any of the preceding claims, wherein an emission treatment apparatus is installed before or after the venturi apparatus or connection point depending on the requirement of excess oxygen for reducing emissions.

22. A turbomachinery assembly as claimed in any of the preceding claims, wherein the venturi apparatus introduces an obstruction which serves to operatively reduce the area of the fluid flow path, thereby increasing the flow speed around the obstruction and to decrease the local static pressure, in use, so as to create the venturi effect.

23. A turbomachinery assembly as claimed in any of the preceding claims, wherein the leading edge of the obstruction in the venturi apparatus or connection point is curved, flat or bluff body so as to operatively reduce the effective flow area while creating a flow separation region behind the obstruction in the absence of feed flow.

24. A turbomachinery assembly as claimed in claim 23, wherein the obstruction is provided by a blind circular feed conduit entering the motive conduit at an angle. In this embodiment, the feed conduit may enter the motive conduit at an inclined angle.

25. A turbomachinery assembly as hereinbefore described, with reference to and as illustrated in any of the accompanying diagrammatic drawings.
